(19) United States
(12) Patent Application Publication
(10) Pub. No.: US 2014/0036149 A1
(43) Pub. Date: Feb. 6, 2014

(54) INFORMATION PROCESSOR AND INFORMATION PROCESSING METHOD

(71) Applicant: KABUSHIKI KAISHA TOSHIBA, Tokyo (JP)

(72) Inventors: Shuta OGAWA, Kanagawa (JP); Yoshihiro OHMORI, Tokyo (JP)

(73) Assignee: KABUSHIKI KAISHA TOSHIBA, Tokyo (JP)

(21) Appl. No.: 13/776,524

(22) Filed: Feb. 25, 2013

(30) Foreign Application Priority Data
Jul. 31, 2012 (JP) P2012-170247

(51) Int. Cl. H04N 5/445; H04N 7/088

(52) U.S. Cl. CPC H04N 5/44591; H04N 7/0882
USPC 348/468; 348/564

(57) ABSTRACT

According to one embodiment, an information processor includes a display controller and a transmitter. The display controller is configured to cause a display module to display a screen on which a plurality of content images based on a plurality of pieces of content data are arranged. The transmitter is configured to receive a captured image including at least one of the content images in at least a portion of the captured image, to specify a content image to be transmitted based on the captured image and the at least one of the content images, and to transmit one of the pieces of content data corresponding to the content image to be transmitted to a predetermined external device.

### CROSS-REFERENCE TO RELATED APPLICATIONS

This application is based upon and claims the benefit of priority from Japanese Patent Application No. 2012-170247, filed Jul. 31, 2012, the entire contents of which are incorporated herein by reference.

### FIELD

Embodiments described herein relate generally to an information processor and an information processing method.

### BACKGROUND

Due to the advancement of high-functionality, large-sized screen, and high-definition in digital television, there is emerged a digital television that simultaneously displays, on a display module, a plurality of content images which are base on a plurality of pieces of content data, such as videos for television, homepages of websites, and photographs. In the future, the number of such digital televisions is likely to increase.

Furthermore, because the digital television has become connectable to a network, a function to transmit a content image displayed on the digital television to another device (for example, a smartphone, a tablet device, and a personal computer) connected to the same network is becoming widely spread.

Specifically, upon transmission of a certain content image among a plurality of content images displayed on the display module of the digital television to another device, a user needs to specify the content image to be transmitted from among the content images using a graphical user interface (GUI) and a remote controller. For example, a marking of some sort is displayed with a content image that is focused (for example, an outer frame of the content image is made to flash) among the content images displayed on the display module of the digital television, and the focus is changed in response to the operation of up-down and left-right (scroll) keys of the remote controller. Then, when an entry key of the remote controller is pressed after the content image to be transmitted is focused, content data corresponding to the focused content image is transmitted to the other device.

Here, if sizes of the content images displayed on the display module of the digital television differ from one another, the content images might not be arranged in a grid-like pattern. If the content images are not arranged in a grid-like pattern on the display module, depending on a layout of the content images, it might be difficult to predict which one is to be next focused upon operation of the up-down and left-right keys on the remote controller. Accordingly, it is not easy to specify a content image to be transmitted from among the content images arranged on the display module in a complex layout using only the GUI and the remote controller. Furthermore, if the number of content images arranged on the display module increases, it is not easy to select a content image to be transmitted from among the large number of content images using the remote controller even if the content images are arranged in a grid-like pattern.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of a configuration of an information processing system according to a first embodiment;

FIG. 2 is an exemplary block diagram of a configuration of a digital television and a configuration of a mobile terminal comprised in the information processing system, in the first embodiment;

FIG. 3 is an exemplary sequence diagram of a transmission processing of content data performed in the information processing system in the first embodiment;

FIG. 4 is an exemplary diagram for explaining other method in the digital television for specifying a content image to be transmitted, in the first embodiment;

FIG. 5 is an exemplary diagram for explaining the other method in the digital television for specifying the content image to be transmitted, in the first embodiment;

FIG. 6 is an exemplary diagram of a display example of a content image displayed on the mobile terminal of the information processing system in the first embodiment;

FIG. 7 is an exemplary diagram of a display example of a content image displayed on the mobile terminal of the information processing system in the first embodiment;

FIG. 8 is an exemplary diagram of a display example of a content image displayed on the mobile terminal of the information processing system in the first embodiment;

FIG. 9 is an exemplary diagram of a configuration of an information processing system according to a second embodiment;

FIG. 10 is an exemplary block diagram of a configuration of a digital television and a configuration of a mobile terminal comprised in the information processing system in the second embodiment;

FIG. 11 is an exemplary sequence diagram of a transmission processing of content data performed in the information processing system in the second embodiment;

FIG. 12 is an exemplary diagram of a configuration of an information processing system according to a third embodiment; and

FIG. 13 is an exemplary block diagram of a configuration of a digital television and a configuration of a mobile terminal comprised in the information processing system in the third embodiment.

### DETAILED DESCRIPTION

In general, according to one embodiment, an information processor comprises a display controller and a transmitter. The display controller is configured to cause a display module to display a screen on which a plurality of content images based on a plurality of pieces of content data are arranged. The transmitter is configured to receive a captured image comprising at least one of the content images in at least a portion of the captured image, to specify a content image to be transmitted based on the captured image and the at least one of the content images, and to transmit one of the pieces of content data corresponding to the content image to be transmitted to a predetermined external device.

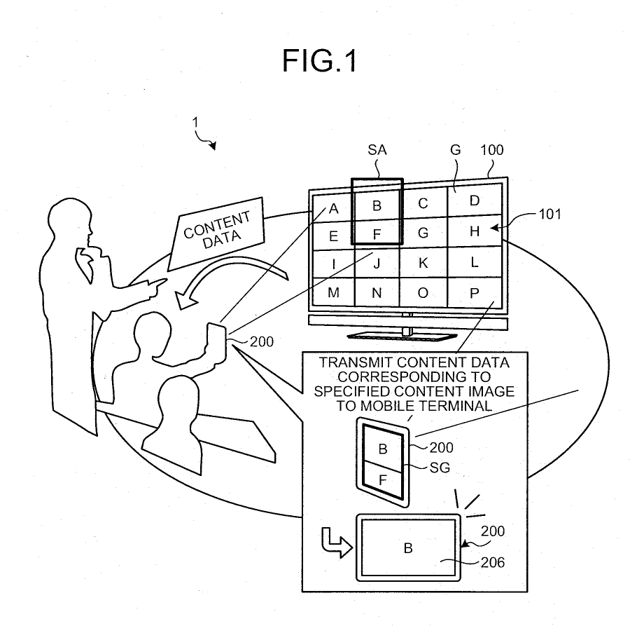

FIG. 1 is a diagram illustrating a configuration of an information processing system according to a first embodiment. An information processing system 1 in the first embodiment comprises a digital television 100 and a mobile terminal 200. The digital television 100 is configured to make a display module 101 to display a screen G on which a plurality of content images A to P (for example, videos for television, websites, and photographs) which are based on a plurality of content data are arranged. The mobile terminal 200 is configured to receive from the digital television 100 content data corresponding to a content image to be transmitted specified based on a captured image SG comprising, in at least a portion thereof, at least one of the content images arranged on the screen G and based on the at least one of the content images. Here, the captured image SG comprises the at least one of the content images in at least a portion of the captured image SG. The digital television 100 is an example of an information processor. The mobile terminal 200 is an example of a predetermined external device.

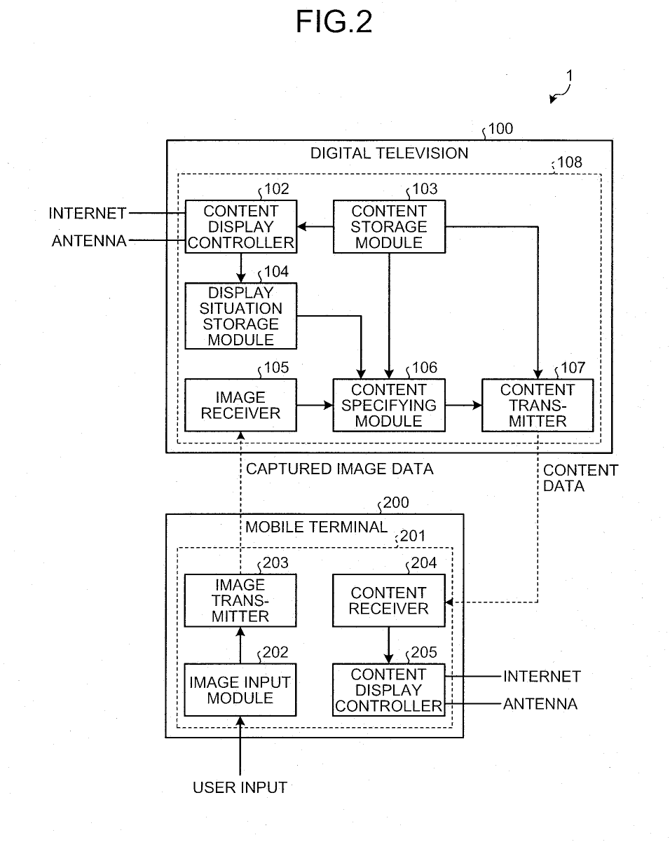

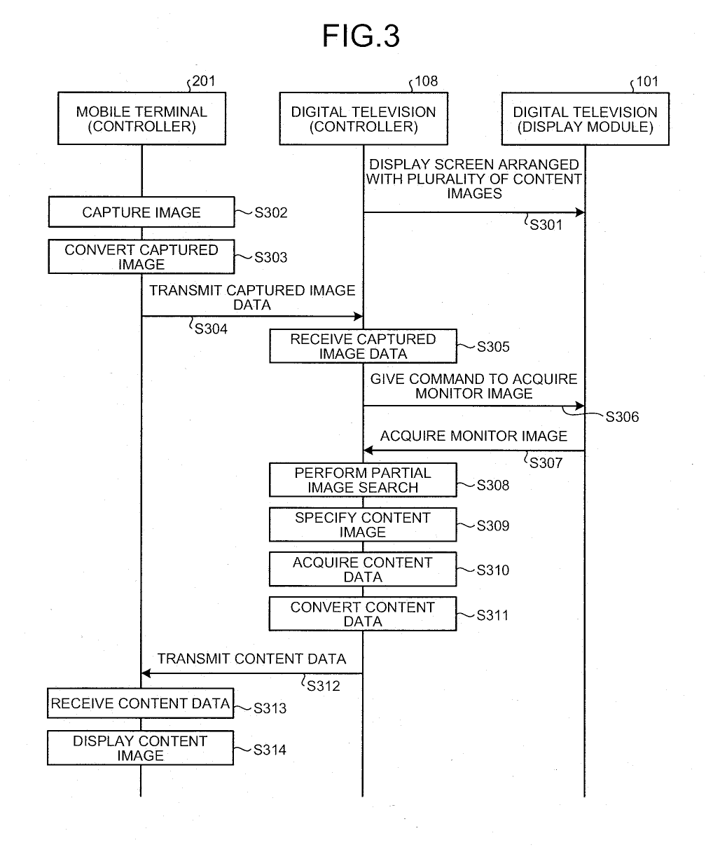

Next, with reference to FIGS. 1 to 3, a flow of a transmission processing of content data performed in the information processing system 1 in the first embodiment will be described. FIG. 2 is a block diagram illustrating a configuration of the digital television and a configuration of the mobile terminal comprised in the information processing system in the first embodiment. FIG. 3 is a sequence diagram illustrating a flow of a transmission processing of content data performed in the information processing system in the first embodiment.

The digital television 100 in the first embodiment comprises a controller 108 configured to control respective modules in the digital television 100. The controller 108 comprises a content display controller 102, a content storage module 103, a display situation storage module 104, an image receiver 105, a content specifying module 106, and a content transmitter 107. The content storage module 103 stores therein content data corresponding to content images to display such as videos for television, websites, and photographs. The display situation storage module 104 stores therein a screen shot of the screen G displayed on the display module 101 (i.e., an image obtained by capturing the screen G; hereinafter, referred to as a monitor image) and the display time and date of the monitor image displayed on the display module 101, in association with each other. In the first embodiment, the display situation storage module 104 stores therein the monitor image of the screen G displayed on the display module 101 in association with the display time and date in seconds, for a predetermined time. The predetermined time here is the time required from when an image is captured by the image receiver 105 and until when a content image to be transmitted is specified (for example, a few seconds).

Meanwhile, the mobile terminal 200 in the first embodiment comprises a controller 201 configured to control respective modules in the mobile terminal 200. The controller 201 comprises an image input module 202, an image transmitter 203, a content receiver 204, and a content display controller 205.

The content display controller 102 comprised in the controller 108 of the digital television 100 first causes the display module 101 to display the screen G on which a plurality of content images which are based on a plurality of pieces of content data stored in the content storage module 103 are arranged (S301). The positions of the content images on the screen G and the number of the content images arranged on the screen G here are arbitrarily configurable. In the first embodiment, the content display controller 102 causes the display module 101 to display, as illustrated in FIG. 1, the screen G on which the content images A to P which are based on a plurality of pieces of content data stored in the content storage module 103 are arranged in a grid-like pattern.

While the content display controller 102 causes the display module 101 to display the content images based on the content data to be displayed stored in the content storage module 103 in the first embodiment, it is not limited thereto. For example, the content display controller 102 may cause the content storage module 103 to store therein content identification information identifying content data for displaying videos for television, and acquire the content data on the air via an antenna to cause the display module 101 to display the videos for television based on the content data acquired. The content identification information includes, for example, a type of broadcast waves such as the terrestrial digital broadcasting, the broadcasting satellite (BS) digital broadcasting, and the communication satellite (CS) digital broadcasting, or a channel number.

Furthermore, the content display controller 102 may cause the content storage module 103 to store therein the content identification information identifying content data for displaying a homepage of a website (for example, a homepage address), and download a hyper text markup language (HTML) file for describing a homepage and image data via the Internet to cause the display module 101 to display the homepage based on the HTML file and the image data downloaded. Alternatively, the content display controller 102 may cause the content storage module 103 to store therein the HTML file for describing the homepage and the image data, and causes the display module 101 to display the homepage based on the HTML file and the image data stored in the content storage module 103.

The image input module 202 comprised in the controller 201 of the mobile terminal 200 comprises so-called a camera, and captures an image as the captured image SG (S302). Here, at least a portion of the captured image SG comprises at least one of the content images arranged on the screen G displayed on the display module 101 of the digital television 100. In this case, a user of the mobile terminal 200, as illustrated in FIG. 1, adjusts the mobile terminal 200 so that a content image to be transmitted from the digital television 100 is included in a capture area SA by the image input module 202. The captured image SG only needs to include at least a portion of the content image to be transmitted. However, the ratio of the content image to be transmitted within the captured image SG has an influence on accuracy in specifying the content image to be transmitted when there exist a number of content images in the captured image SG. Therefore, it is preferable to adjust the mobile terminal 200 so that the ratio of the content image to be transmitted in the captured image SG becomes high.

The image transmitter 203 comprised in the controller 201 of the mobile terminal 200 converts the captured image SG taken by the image input module 202 into captured image data in a format that the digital television 100 can receive (S303). In the first embodiment, in order to reduce a load on the network upon transmission of the captured image data to the digital television 100 via the network, the image transmitter 203 compresses the captured image data to transmit to the digital television 100. The format that the digital television 100 can receive is a format in which the captured image SG is reproducible from the captured image data in the digital television 100. The image transmitter 203 acquires, from the digital television 100, format information concerning the format that the digital television 100 can receive. The image transmitter 203 acquires the format information from the digital television 100 before the process of receiving a content image to transmit from the digital television 100 is performed. In the first embodiment, the image transmitter 203 transmits terminal information related to the mobile terminal 200 to the digital television 100. The terminal information includes: information on whether the content display controller 205 can acquire content data by being connected to the Internet or an antenna; information on a format of content data displayable on the display module 206 of the mobile terminal 200 by the content display controller 205; and/or the like.

The image transmitter 203 comprised in the controller 201 of the mobile terminal 200 transmits to the digital television 100 the captured image data converted into a format that the digital television 100 can receive (S304). In the first embodiment, the image transmitter 203 performs packet communication with the digital television 100 using a wireless local area network (LAN) and such to transmit the captured image data converted into the format that the digital television 100 can receive, to the digital television 100. In the first embodiment, the mobile terminal 200 and the digital television 100 exchange the captured image data by the packet communication. However, the captured image data may be exchanged, for example, by burst communication. Meanwhile, if at least a portion of the content image included in the captured image SG taken by the image input module 202 is a moving image such as videos for television, the captured image SG taken by the image input module 202 differs from the content image currently being displayed on the display module 101. Consequently, even if the captured image SG is compared with the content image arranged on the screen G currently displayed on the display module 101, it cannot be specified which one of the content images arranged on the screen G is comprised in the captured image SG. Therefore, the image transmitter 203 transmits the captured image data with date and time of when the captured image SG is captured (in the present embodiment, the data and time is in seconds), to the digital television 100.

The image receiver 105 comprised in the controller 108 of the digital television 100 receives from the mobile terminal 200 the captured image data representing the captured image SG taken by the mobile terminal 200 (S305). In the first embodiment, the image receiver 105 performs packet communication with the digital television 100 using a wireless LAN and such to receive the captured image data.

The content specifying module 106 comprised in the controller 108 of the digital television 100 receives the captured image data received, and with the captured image data as a query, provides a command to the display module 101 to acquire a monitor image of the screen G displayed on the display module 101 at the time and date (time and date attached to the captured image data) the captured image SG represented by the captured image data received is taken (S306). The content specifying module 106 then acquires the monitor image of the screen G from the display module 101 (S307). However, if the content images arranged on the screen G include a content image of a moving image such as video for television or of a website in which the display information (appearance) thereof varies over time, the content specifying module 106 acquires the monitor image stored in the display situation storage module 104 in association with the displayed time and date corresponding to the time and date attached to the captured image data.

Next, the content specifying module 106 performs a partial image search for specifying the content image to be transmitted from the content images arranged on the screen G, based on the captured image SG represented by the received captured image data and the content image included in the acquired monitor image (S308). Specifically, as the content image to be transmitted, the content specifying module 106 specifies a content image with a degree of similarity to the captured image of higher than a preset value, from among the content images arranged on the screen G. In the first embodiment, the content specifying module 106 calculates the degree of similarity to the captured image SG for each of the content images included in the monitor image acquired, and specifies the content image with the calculated degree of similarity of higher than the preset value. If the content images arranged on the screen G include a content image of moving images or of a website in which the display information thereof varies over time, the content specifying module 106 specifies, as the content image to be transmitted, a content image having a display history with a degree of similarity to the captured image SG of higher than a preset value, from among the content images (i.e., a monitor image acquired from the display situation storage module 104). Consequently, a failure in the partial image search due to the difference between the content image currently being displayed on the display module 101 and the captured image SG can be prevented.

Now, another method of partial image search will be described. Here, it is assumed that the display situation storage module 104 stores therein the screen G displayed on the display module 101 as a single monitor image X for a few seconds. The content specifying module 106 acquires from the display situation storage module 104 the monitor image X displayed at the time and date attached to the received captured image data. The content specifying module 106 then searches in a scalable manner which area in the acquired monitor image X has a high degree of similarity to the captured image SG represented by the received captured image data. For example, when a content image to be transmitted is specified based on the monitor image X and the captured image SG that is a partial image obtained by capturing a portion of the monitor image X, the content specifying module 106 searches which area of the monitor image X matches (or resembles) the captured image SG. In this case, the content specifying module 106 uses a method that can search from the monitor image X a portion that matches (or resembles) the captured image SG even when the captured image SG is an enlarged or reduced image of a certain portion of the monitor image X. The content specifying module 106 then, in the monitor image acquired, specifies coordinates of an area with a degree of similarity to the captured image SG of higher than a preset value. The content specifying module 106, by storing therein coordinates of each of the content images on the screen G displayed on the display module 101 (hereinafter, referred to as display coordinates), compares the coordinates specified with the display coordinates to specify the content image to be transmitted corresponding to the captured image SG.

If the content images arranged on the screen G include a number of content images each with the degree of similarity to the captured image SG of higher than the preset value, the content specifying module 106 specifies, as the content image to be transmitted, a content image comprising an area with the degree of similarity to the captured image SG of higher than the preset value from among the content images arranged on the screen G (S309). Here, a ratio of the area within the content image is greater than or equal to a predetermined ratio. Consequently, when a number of content images with the degree of similarity to the captured image SG of higher than the preset value are specified from among the content images, only a content image with high possibility of being desired to be transmitted by a user can be specified as the content image to be transmitted, from among the number of content images each with the degree of similarity to the captured image SG of higher than the preset value.

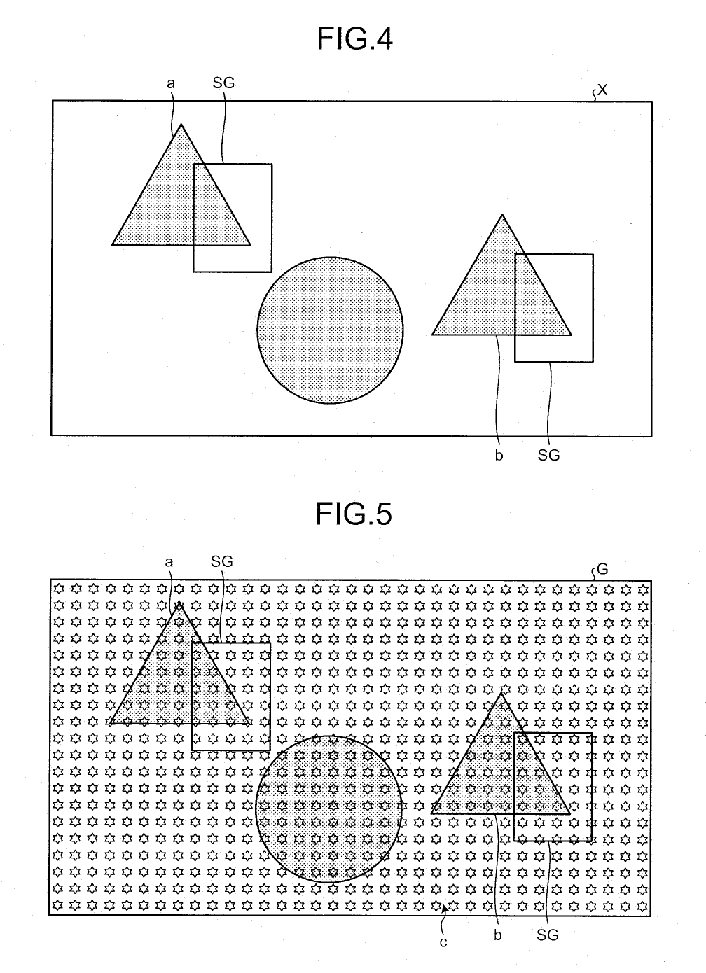

Now, with reference to FIGS. 4 and 5, yet another method is described by which the content specifying module 106 specifies a content image to be transmitted when a number of content images, the area of which matches the captured image SG (or the area with the degree of similarity of higher than a preset value), are included in the monitor image X. FIGS. 4 and 5 are diagrams for explaining the other method performed to specify a content image to be transmitted in the digital television in the first embodiment. For example, as illustrated in FIG. 4, when the monitor image X includes a number of content images a and b that match (or resemble) the captured image SG, the content specifying module 106 cannot specify which one of the content images a and b is captured as the captured image SG. Therefore, in the first embodiment, the content display controller 102 causes the display module 101 to display, as illustrated in FIG. 5, the screen G that includes digital watermarks c representing the coordinates of the content images a and b in the monitor image X, in addition to the content images a and b. In the first embodiment, the content display controller 102 includes the digital watermarks c in the screen G when the image capturing of the captured image SG is started by the image input module 202 in the mobile terminal 200. Then, the content display controller 102 terminates displaying the digital watermarks c on the screen G when the image capturing of the captured image SG is finished. Accordingly, during a period when the digital watermarks c are not displayed, degradation of the image quality of the screen G can be prevented. In the first embodiment, the content display controller 102 further arranges the digital watermarks c on the screen G such that the captured image SG in which the content images a and b arranged on the screen G are captured includes at least one of the digital watermarks c. When the digital watermarks c are included in the received captured image SG, the content specifying module 106 specifies that, by referring to the digital watermarks c included in the captured image SG, which one of the content images a and b is captured as the captured image SG. Consequently, the content image to be transmitted can be specified without performing a partial image search. Furthermore, when the content images a and b that match (or resemble) the captured image SG are included in the monitor image X, it is not possible to specify that, by a partial image search, which one of the content images a or b is captured as the captured image SG. However, by referring to the digital watermarks c, it can be specified which one of the content image a or b is captured.

Next, the content transmitter 107 comprised in the controller 108 of the digital television 100 acquires from the content storage module 103 the content data corresponding to the content image to be transmitted specified by the content specifying module 106 (S310). While the content transmitter 107 acquires from the content storage module 103 the content data corresponding to the content image to be transmitted in the first embodiment, the embodiment is not limited thereto. For example, the content transmitter 107 may acquire, by referring to the terminal information received from the mobile terminal 200, content identifying information that identifies the content data corresponding to the content image to be transmitted as the content data. Specifically, when the terminal information received from the mobile terminal 200 represents that the content display controller 205 is connected to the Internet and the antenna and is able to acquire content data, and when the content image to be transmitted is based on content data acquirable via the Internet and the antenna such as websites and videos for the television, the content transmitter 107 acquires the content identifying information as the content data corresponding to the content image to be transmitted.

Now, the reason for referring to the terminal information received from the mobile terminal 200 upon transmission of the content identifying information as the content data will be described. In the first embodiment, as illustrated in FIG. 2, the content display controller 205 is connected to the Internet and the antenna. Accordingly, the content display controller 205 can acquire, via the Internet or the antenna, the content data identified by the content identifying information transmitted as the content data from the digital television 100. However, when the image receiver 105 is not connected to the Internet and the antenna, the content display controller 205 is unable to acquire the content data using the content identifying information transmitted from the digital television 100. Therefore, if the digital television 100 recognizes in advance the environment of the mobile terminal 200, for example, whether the content display controller 205 is connected to the Internet, the digital television 100 can transmit appropriate content data to the mobile terminal 200. As a result, the occurrence of incidents in which the mobile terminal 200 fails to display the content image which is based on the content data can be kept at minimum. Furthermore, if the environment of the mobile terminal 200 is recognized in advance, the digital television 100 can warn the mobile terminal 200 that the content image which is based on the content data cannot be displayed on the mobile terminal 200 before transmission of the content data corresponding to the specified content image.

In the first embodiment, the digital television 100 receives the terminal information from the mobile terminal 200 via the image receiver 105 to recognize in advance the environment of the mobile terminal 200. Specifically, the digital television 100 receives the terminal information from the mobile terminal 200 by the image receiver 105 before a series of processes illustrated in FIG. 3 is performed.

When the content display controller 205 of the mobile terminal 200 is not connected to the Internet, for example, the content transmitter 107 then acquires the content data to display the content image specified off-line (for example, an HTML file and image data). Consequently, even when the content display controller 205 of the mobile terminal 200 is unable to connect to the Internet and to download the content data, the mobile terminal 200 is able to display the content image.

Furthermore, in case when for example the content display controller 205 of the mobile terminal 200 is not connected to the antenna and when the content transmitter 107 transmits to the mobile terminal 200 the content identifying information such as a channel indicating an on-air program and a type of broadcast waves (for example, terrestrial digital broadcasting, BS digital broadcasting, or CS digital broadcasting), the content display controller 205 is unable to acquire the content data identified by the content identifying information. Therefore, when the content display controller 205 of the mobile terminal 200 is not connected to the antenna and when the content image specified is video for television, the content transmitter 107 warns to a user that the specified content image cannot be displayed on the mobile terminal 200 (for example, displays a dialog on the display module 101).

The content transmitter 107 comprised in the controller 108 of the digital television 100 converts the content data acquired into a format displayable on the mobile terminal 200 (S311). In the first embodiment, the content transmitter 107 refers to the terminal information received from the mobile terminal 200 (information concerning the format of content data displayable on the display module 206 by the content display controller 205) and converts the format of the content data acquired. Furthermore, in the first embodiment, in order to reduce the network load upon transmission of the content data to the mobile terminal 200 via the network, the content transmitter 107 compresses the content data.

The content transmitter 107 then transmits the content data corresponding to the content image to be transmitted, which is specified by the content specifying module 106, to the mobile terminal 200 (S312). In the first embodiment, the content transmitter 107 transmits to the mobile terminal 200 the content data converted into the format displayable on the mobile terminal 200. Furthermore, in the first embodiment, the content transmitter 107 performs packet communication with the mobile terminal 200 using a wireless LAN and such to transmit to the mobile terminal 200 the content data corresponding to the content image to transmit specified. Furthermore, while the content transmitter 107 transmits the content data corresponding to the content image to be transmitted to the mobile terminal 200, which is the transmitting source of the captured image data in the first embodiment, it only needs to transmit to a predetermined external device such as a mobile terminal registered in advance to the digital television 100. In other words, in the first embodiment, the content specifying module 106 and the content transmitter 107 serve as a transmitter. In the first embodiment, the content transmitter 107 further transmits to the mobile terminal 200, together with the content data corresponding to the content image to be transmitted, a magnification ratio of an area that matches (or resembles) the captured image SG in the monitor image X and coordinates of the area in the monitor image X.

The content receiver 204 comprised in the controller 201 of the mobile terminal 200 receives the content data transmitted from the digital television 100 (S313). In the first embodiment, the content receiver 204 performs packet communication with the digital television 100 using a wireless LAN and such to receive the content data from the digital television 100. In the first embodiment, the content receiver 204 further receives the magnification ratio and the coordinates together with the content data.

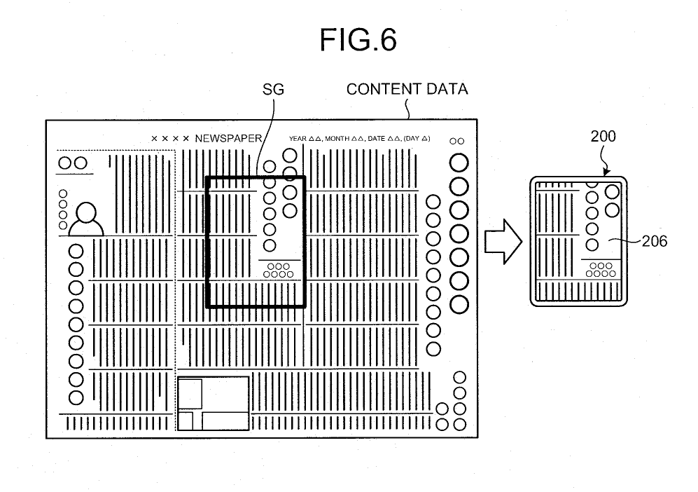

The content display controller 205 comprised in the controller 201 of the mobile terminal 200 causes the display module 206 to display the content image which is based on the content data received by the content receiver 204 (S314). In the first embodiment, when the content data received by the content receiver 204 is the content identifying information identifying the content data corresponding to the content image to be transmitted, the content display controller 205 acquires the content data identified by the content identifying information via the Internet or the antenna, and causes the display module 206 to display the content image which is based on the acquired content data. FIG. 6 is a diagram illustrating a display example of the content image displayed on the mobile terminal 200 in the information processing system in the first embodiment. In the first embodiment, upon causing the display module 206 to display the content image which is based on the received content data, the content display controller 205, as illustrated in FIG. 6, causes the display module 206 to magnify an image of an area specified by the received coordinates from among the content image, which is based on the received content data, by the received magnification, and displays the magnified image. Consequently, the content display controller 205 can cause the display module 206 to display the partial image captured by the image input module 202 from among the content image by the magnification displayed on the digital television 100.

For example, as illustrated in FIG. 1, when the captured image SG including a content image B and a content image F arranged on the screen G is captured by the image input module 202 of the mobile terminal 200, the image transmitter 203 transmits captured image data representing the captured image SG to the digital television 100. When the captured image data is received by the image receiver 105, the content specifying module 106 of the digital television 100 specifies the content image B and the content image F to be transmitted from among the content images A to P arranged on the screen G, based on the captured image SG represented by the captured image data and the content images included in the monitor image. In this case, the content specifying module 106 may specify only the content image B including an area, the degree of similarity of which to the captured image SG is higher than the preset value and a ratio of which within the content image is greater than or equal to a predetermined ratio, as the content image to be transmitted from among the content image B and the content image F. Next, the content transmitter 107 acquires from the content storage module 103 the content data corresponding to the content image B specified. The content transmitter 107 then transmits the acquired content data to the mobile terminal 200. The content display controller 205 of the mobile terminal 200 causes the display module 206 to display the content image B which is based on the content data received by the content receiver 204.

In the first embodiment, the content transmitter 107 transmits, to the mobile terminal 200, only the content data corresponding to the content image to be transmitted specified by the content specifying module 106. However, the content transmitter 107 may transmit, to the mobile terminal 200, the content data corresponding to all of the content images on the screen G on which the content image to be transmitted specified by the content specifying module 106 is arranged. In that case, the content transmitter 107 transmits to the mobile terminal 200, together with the content data, data identifying information for identifying, from among the content data transmitted to the mobile terminal 200, the content data corresponding to the content image to be transmitted specified by the content specifying module 106.

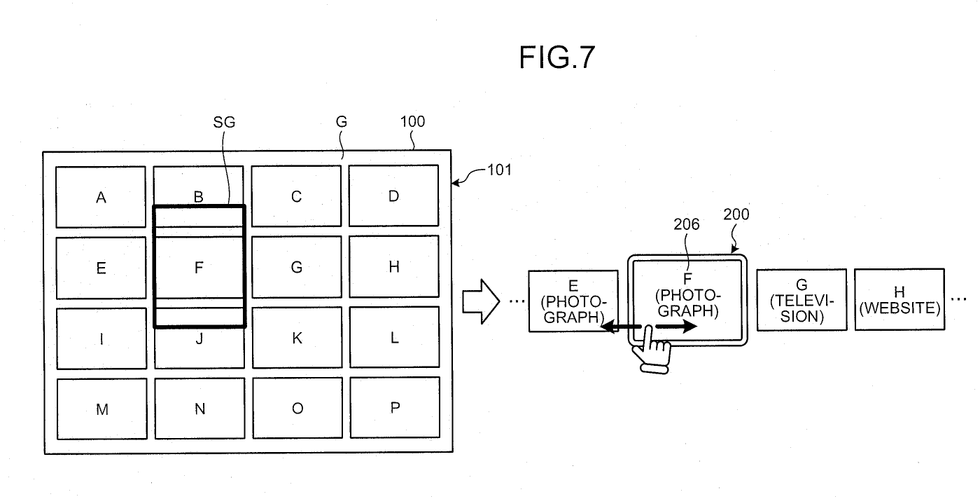

FIG. 7 is a diagram illustrating a display example of a content image displayed on the mobile terminal in the information processing system in the first embodiment. Upon receipt of the content data corresponding to all of the content images on the screen G on which the content image corresponding to the content image to be transmitted is arranged from the digital television 100, the content display controller 205 causes the display module 206 to display, as illustrated in FIG. 7, the content image (the content image to be transmitted) which is based on the content data identified by the data identifying information received together with the content data. Then, in response to the operation of flick input and such on the mobile terminal 200, the content display controller 205 may switch, as illustrated in FIG. 7, the content image to be displayed on the display module 206 from the content image to be transmitted to the other content images on the screen G on which the content image to be transmitted is arranged.

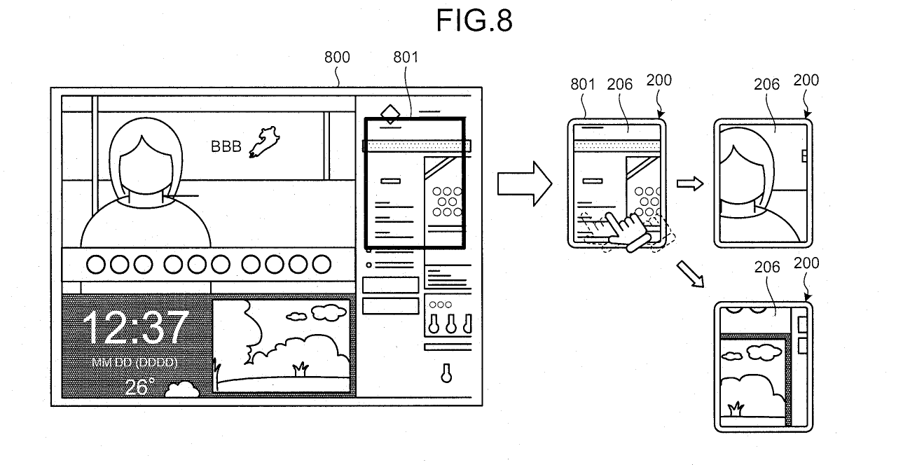

Furthermore, the content transmitter 107 may transmit, together with the content data corresponding to all of the content data on the screen G on which the content image to be transmitted specified by the content specifying module 106 is arranged, the magnification of each of the content images on the screen G and the coordinates of the respective content images. FIG. 8 is a diagram illustrating a display example of the content image displayed on the mobile terminal in the information processing system in the first embodiment. The content display controller 205 refers to the received magnification and coordinates, and as illustrated in FIG. 8, produces an image 800 in which the content images which are based on all of the received content data are arranged in a layout similar to that of the monitor image X. When starting the display of the produced image 800, the content display controller 205 causes the display module 206 to display, as illustrated in FIG. 8, an image 801 of an area that matches (or resembles) the captured image SG from among the produced image 800. Thereafter, in response to the operation on the mobile terminal 200 such as flick input and pinching action, the content display controller 205 switches images to be displayed on the display module 206 among the produced image. This allows viewing of an image similar to that displayed on the digital television 100 on the mobile terminal 200.

As in the foregoing, in accordance with the digital television 100 in the first embodiment, a content image to be transmitted is specified from the content images arranged on the screen G based on the captured image SG comprising, in at least a portion thereof, the content images arranged on the screen G displayed on the display module 101 and the content images included in a monitor image. Then, the content data corresponding to the specified content image to be transmitted is transmitted to the mobile terminal 200. Accordingly, the mobile terminal 200 can display a desired content image merely by inputting the captured image SG in which a desired content image is captured to the digital television 100. Thus, an intuitive and easy-to-understand operational feeling can be provided to the user when specifying the content image to be transmitted from among a plurality of content images displayed on the display module 101.

In a second embodiment, a content image to be transmitted is specified from among a plurality of content images based on an input sound representing a position of the content image on a screen displayed on a display module and a type of content data corresponding to the content image. Then, content data corresponding to the specified content image to be transmitted is transmitted to a predetermined external device. In the following, the description of configurations similar to that of the information processing system 1 in the first embodiment will be omitted, and configurations different from that of the information processing system 1 in the first embodiment will be described.

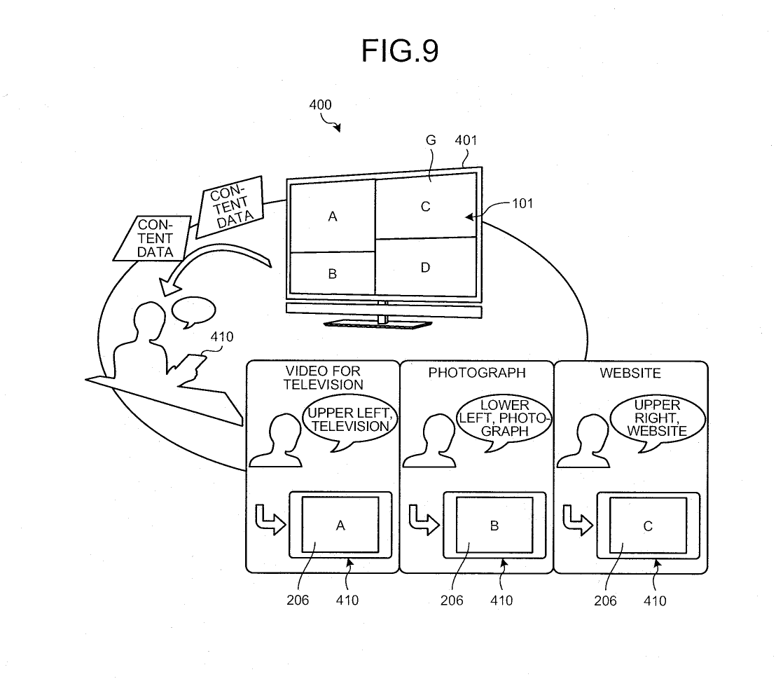

FIG. 9 is a diagram illustrating a configuration of an information processing system according to the second embodiment. An information processing system 400 in the second embodiment comprises: a digital television 401 that is an example of an information processor configured to cause the display module 101 to display the screen G on which a plurality of content images A to D which are based on a plurality of content data are arranged; and a mobile terminal 410 that is an example of a predetermined external device configured to receive content data corresponding to a content image specified based on a sound input to the digital television 401 (for example, “television”; “upper right, photograph”; and “website”) and to cause the display module 206 to display the content image that is based on the received content data.

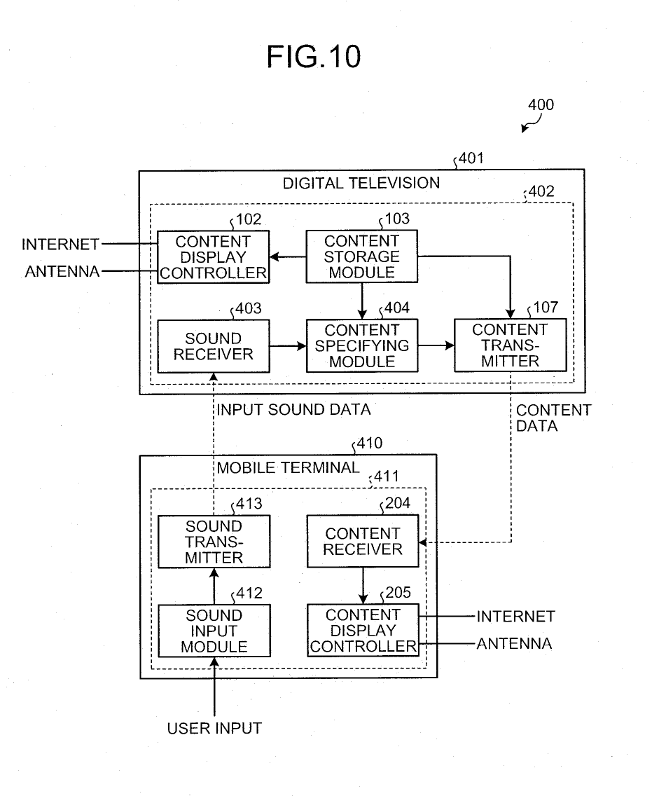

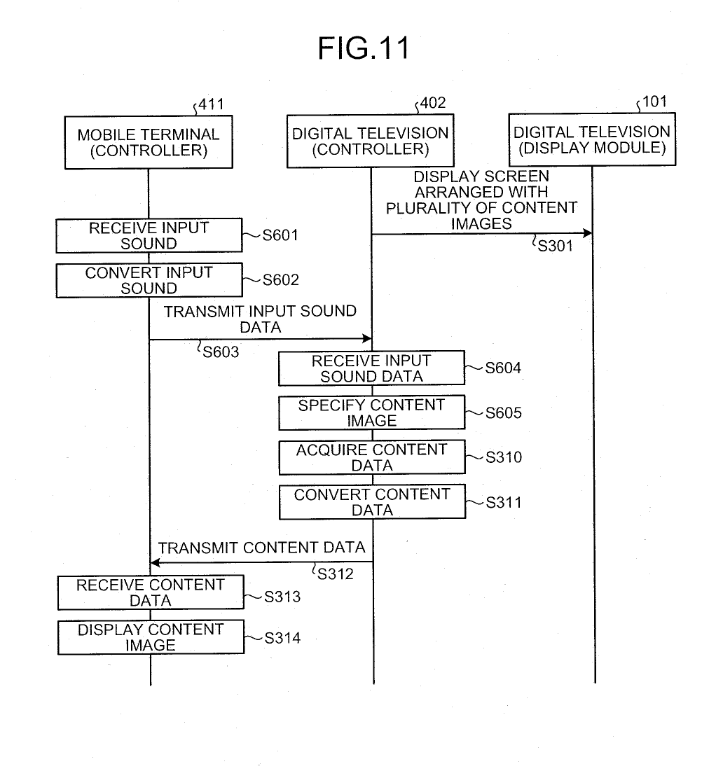

Next, with reference to FIGS. 9 to 11, a flow of a transmission processing of content data performed in the information processing system 400 in the second embodiment will be described. FIG. 10 is a block diagram illustrating a configuration of the digital television and a configuration of the mobile terminal comprised in the information processing system in the second embodiment. FIG. 11 is a sequence diagram illustrating a flow of a transmission processing of content data performed in the information processing system in the second embodiment.

The digital television 401 in the second embodiment comprises a controller 402 that controls respective modules in the digital television 401. The controller 402 comprises the content display controller 102, the content storage module 103, the content transmitter 107, a sound receiver 403, and a content specifying module 404.

Meanwhile, the mobile terminal 410 in the second embodiment comprises a controller 411 that controls respective modules in the mobile terminal 410. The controller 411 comprises the content receiver 204, the content display controller 205, a sound input module 412, and a sound transmitter 413.

The content display controller 102 comprised in the controller 402 of the digital television 401 first causes the display module 101 to display the screen G on which a plurality of content images are arranged (S301). Here, the content images are based on a plurality of content data stored in the content storage module 103. In the second embodiment, the content display controller 102 arranges, as illustrated in FIG. 9, the content image A (videos for television) on the upper left of the screen G, the content image B (photograph) on the lower left of the screen G, the content image C (website) on the upper right of the screen G, and the content image D (photograph) on the lower right of the screen G.

The sound input module 412 comprised in the controller 411 of the mobile terminal 410 is composed of a microphone and such, and receives an input sound specifying a content image to be transmitted (S601). The input sound here is keywords representing a position of a content image to be transmitted arranged on the screen G and the type of content data corresponding to the content image to be transmitted (for example, “upper left, television”; “lower left, photograph”; “upper right, website”; and “lower right, photograph”). In the second embodiment, the input sound is defined to represent the position of the content image to be transmitted arranged on the screen G. However, when no other content images which are based on content data of the same type as the content data corresponding to the content image to be transmitted are arranged on the screen G, the input sound only needs to represent at least the type of content data corresponding to the content image to be transmitted. The user of the mobile terminal 410 can use help information displayable on the display module 206 of the mobile terminal 200 and description of a manual and such to learn the keyword representing the type of content data corresponding to the content image to be transmitted.

The sound transmitter 413 comprised in the controller 411 of the mobile terminal 410 converts the input sound received by the sound input module 412 into input sound data in a format that the digital television 401 can receive (S602). In the second embodiment, to reduce the network load for the transmission of the input sound data to the digital television 401 via the network, the sound transmitter 413 compresses the input sound data to be transmitted to the digital television 401. The format that the digital television 401 can receive here is a format of input sound data in which speech recognition can be performed in the digital television 401. The sound transmitter 413 acquires, from the digital television 401, format information concerning a format that the digital television 401 can receive. The sound transmitter 413 acquires the format information from the digital television 401 before the process of receiving a content image to be transmitted from the digital television 401 is performed. In the second embodiment, the sound transmitter 413 acquires the format information when performing communication with the digital television 401 for the first time, and transmits terminal information concerning the mobile terminal 410 to the digital television 401. The terminal information here includes whether the content display controller 205 is connected to the Internet and an antenna and is able to acquire content data, information concerning a format of content data displayable on the display module 206 of the mobile terminal 410 by the content display controller 205, and the like.

The sound transmitter 413 comprised in the controller 411 of the mobile terminal 410 transmits, to the digital television 401, the input sound data converted into the format that the digital television 401 can receive (S603). In the second embodiment, the sound transmitter 413 performs packet communication with the digital television 401 using a wireless LAN and such to transmit the input sound data converted into the format that the digital television 401 can receive, to the digital television 401.

The sound receiver 403 comprised in the controller 402 of the digital television 401 receives the input sound data from the mobile terminal 410 (S604). In the second embodiment, the sound receiver 403 performs packet communication with the mobile terminal 410 using a wireless LAN and such to receive the input sound data.

The content specifying module 404 comprised in the controller 402 of the digital television 401 specifies, based on the input sound represented by the received input sound data, the content image to be transmitted from among a plurality of content images arranged on the screen G displayed on the display module 101 (S605). In the second embodiment, the content storage module 103 stores therein content data corresponding to the content images arranged on the screen G and keywords representing the positions of the content images on the screen G and the types of content data corresponding to the content images, in association with each other. The content specifying module 404 then acquires keywords by performing speech recognition on the input sound represented by the input sound data, and performs matching search with respect to each of the keywords stored in the content storage module 103 in association with the content data. As a result of matching search, the content specifying module 404 specifies, as the content image to be transmitted, a content image which is based on content data stored in the content storage module 103 in association with a keyword that matches the keyword acquired from the input sound by performing the speech recognition.

In the second embodiment, the content specifying module 404 specifies a content image to be transmitted based on the keyword acquired by performing the speech recognition on the input sound represented by the input sound data received by the sound receiver 403. However, the content specifying module 404 may specify the content image to be transmitted based on a keyword acquired by performing speech recognition on an input sound received from a sound input module such as a microphone (not depicted) comprised in the digital television 401.

Furthermore, in the second embodiment, the content specifying module 404 comprised in the controller 402 of the digital television 401 performs the speech recognition on the input sound. However, the mobile terminal 410 may perform the speech recognition on an input sound to acquire the keyword and to transmit the acquired keyword to the digital television 401. In that case, when the keyword stored in the content storage module 103 in association with the content data can be freely changed, the changed keyword is transmitted to the mobile terminal 410 before the speech recognition on the input sound is performed in the mobile terminal 410, and the keyword is then specified from the changed keyword by performing speech recognition on the input sound. Furthermore, in the second embodiment, the content specifying module 404 and the content transmitter 107 serve as a transmitter.

For example, as illustrated in FIG. 9, when the user of the mobile terminal 410 inputs “upper left, television” representing the position of the content image A on the screen G and the type of content data corresponding to the content image A as an input sound via the sound input module 412, the sound transmitter 413 transmits input sound data representing “upper left, television” to the digital television 401. When the content specifying module 404 of the digital television 401 receives the input sound data representing “upper left, television” by the sound receiver 403, the content specifying module 404 performs speech recognition to recognize “upper left, television” from the input sound data to acquire a keyword. The content specifying module 404 then specifies the content image A which is based on the content data stored in the content storage module 103 in association with the acquired keyword as a content image to be transmitted. The content specifying module 404 acquires the content data corresponding to the specified content image A from the content storage module 103. The content transmitter 107 transmits the acquired content data to the mobile terminal 410. The content display controller 205 of the mobile terminal 410 causes the display module 206 to display the content image A which is based on the content data received by the content receiver 204.

Furthermore, as illustrated in FIG. 9, when the user of the mobile terminal 410 inputs “lower left, photograph” representing the position of the content image B on the screen G and the type of content data corresponding to the content image B as an input sound via the sound input module 412, the sound transmitter 413 transmits input sound data representing “lower left, photograph” to the digital television 401. When the content specifying module 404 of the digital television 401 receives the input sound data representing “lower left, photograph” by the sound receiver 403, the content specifying module 404 performs speech recognition to recognize “lower left, photograph” from the input sound data to acquire the keyword. The content specifying module 404 then specifies the content image B which is based on the content data stored in the content storage module 103 in association with the acquired keywords as a content image to be transmitted. The content specifying module 404 acquires the content data corresponding to the specified content image B from the content storage module 103. The content transmitter 107 transmits the acquired content data to the mobile terminal 410. The content display controller 205 of the mobile terminal 410 causes the display module 206 to display the content image B which is based on the content data received by the content receiver 204. Consequently, even when the content images B and D which are based on the same type of content data (for example, photograph) are arranged on the screen G, a content image to be transmitted can be specified more accurately from among the content images B and D which are based on the same type of content data.

As illustrated in FIG. 9, when the user of the mobile terminal 410 inputs “upper right, website” representing the position of the content image C on the screen G and the type of content data corresponding to the content image C as an input sound via the sound input module 412, the sound transmitter 413 transmits input sound data representing “upper right, website” to the digital television 401. When the content specifying module 404 of the digital television 401 receives the input sound data representing “upper right, website” by the sound receiver 403, the content specifying module 404 performs speech recognition to recognize “upper right, website” from the input sound data to acquire keywords. The content specifying module 404 then specifies the content image C which is based on the content data stored in the content storage module 103 in association with the acquired keyword as a content image to be transmitted. The content specifying module 404 acquires the content data corresponding to the specified content image C from the content storage module 103. The content transmitter 107 transmits the acquired content data to the mobile terminal 410. The content display controller 205 of the mobile terminal 410 causes the display module 206 to display the content image C which is based on the content data received by the content receiver 204.

As in the foregoing, in accordance with the digital television 401 in the second embodiment, a content image to be transmitted is specified from among a plurality of content images based on an input sound representing the position of a content image on the screen G displayed on the display module 101 and the type of content data corresponding to the content image. Then, content data corresponding to the specified content image to be transmitted is transmitted to the mobile terminal 410. Consequently, the mobile terminal 410 can display the desired content image merely by receiving an input sound representing the position of a desired content image on the screen G and the type of content data corresponding to the content image. Thus, an intuitive and easy-to-understand operational feeling can be provided to the user when the content image to be transmitted is specified from among a plurality of content images displayed on the display module 101.

In a third embodiment, textual information representing a type of content data is displayed on the display module. In the following description, the description of configurations similar to that of the information processing system 400 in the second embodiment will be omitted, and configurations different from that of the information processing system 400 in the second embodiment will be described.

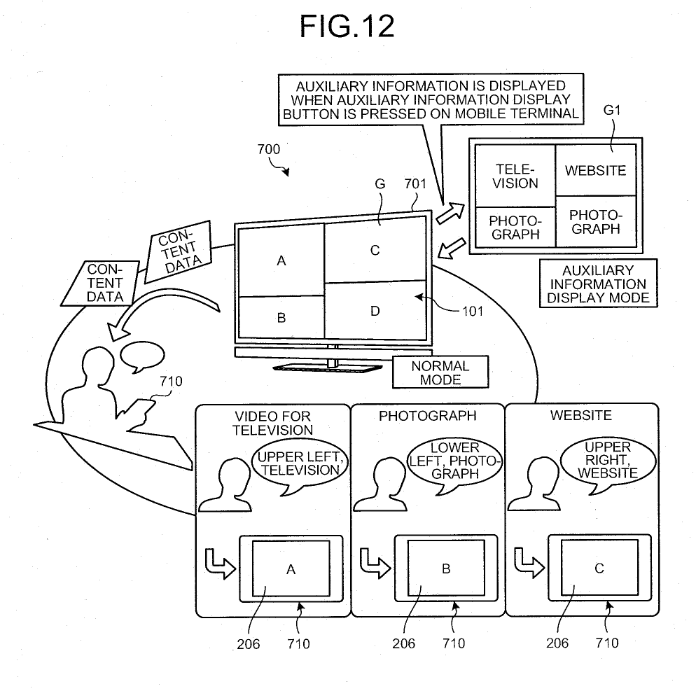

FIG. 12 is a diagram illustrating a configuration of an information processing system according to the third embodiment. An information processing system 700 in the third embodiment comprises a mobile terminal 710 and a digital television 701. The mobile terminal 710 comprises an application for causing the display module 206 to display a button (hereinafter, referred to as an auxiliary information display button) to provide a command to display auxiliary information. Here, the auxiliary information is textual information representing a type of content data. When the auxiliary information display button is pressed, the mobile terminal 710 transmits an auxiliary information display command for displaying the auxiliary information. Upon receipt of the auxiliary information display command from the mobile terminal 710, the digital television 701 changes modes from a normal mode in which the screen G is displayed to an auxiliary information display mode in which a screen G1 arranged with the auxiliary information is displayed.

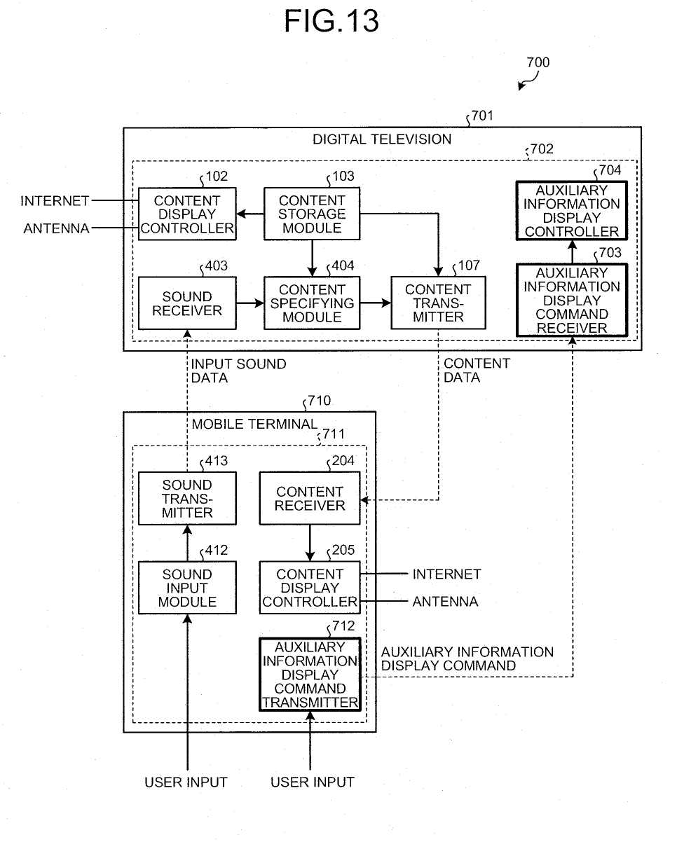

Next, with reference to FIGS. 12 and 13, the process of displaying auxiliary information in the information processing system 700 in the third embodiment will be described. FIG. 13 is a block diagram illustrating a configuration of the digital television and a configuration of the mobile terminal comprised in the information processing system in the third embodiment.

The digital television 701 in the third embodiment comprises a controller 702 that controls respective modules in the digital television 701. The controller 702 comprises the content display controller 102, the content storage module 103, the content transmitter 107, the sound receiver 403, the content specifying module 404, an auxiliary information display command receiver 703, and an auxiliary information display controller 704.

Meanwhile, the mobile terminal 710 in the third embodiment comprises a controller 711 that controls respective modules in the mobile terminal 710. The controller 711 comprises the content receiver 204, the content display controller 205, the sound input module 412, the sound transmitter 413, and an auxiliary information display command transmitter 712.

When the user of the mobile terminal 710 performs an input operation for displaying of the auxiliary information by operating the mobile terminal 710 (in the third embodiment, by pressing of the auxiliary information display button), the auxiliary information display command transmitter 712 transmits the auxiliary information display command to the digital television 701.

The auxiliary information display command receiver 703 receives the auxiliary information display command transmitted from the mobile terminal 710.

The auxiliary information display controller 704 causes the display module 101 to display auxiliary information when the auxiliary information display command is received. More specifically, the auxiliary information display controller 704 superimposes (overlays) auxiliary information on a content image, which is based on the type of content data represented by the auxiliary information, and causes the display module 101 to display the superimposed auxiliary information. In the third embodiment, when the auxiliary information display command is received in a manner as described above, the auxiliary information display controller 704 changes modes from the normal mode to the auxiliary information display mode. Here, in the normal mode, the screen G is displayed on the display module 101. On the other hand, in the auxiliary information display mode, the screen G1 is displayed on the display module 101. In the third embodiment, the content display controller 102 and the auxiliary information display controller 704 serve as a display controller.

The screen G1 displayed on the display module 101 when the mode is changed to the auxiliary information display mode will be described. For example, as illustrated in FIG. 12, when four content images A to D are displayed on the screen G, the brightness of the screen G is lowered to about 50% of that in the normal mode, and on the content images A to D arranged on the screen G, the screen G1 arranged with the auxiliary information (for example, in white letters) representing the type of content data corresponding to each of the content images A to D is displayed. More specifically, the auxiliary information display controller 704 arranges the auxiliary information representing “television” on the content image A, the auxiliary information representing “photograph” on the content images B and D, and the auxiliary information representing “website” on the content image C. When inputting an input sound, the user needs to know what kind of sound needs to be input to specify the content images on the screen G. Conventionally, the user is unable to know the input sound unless the user reads help information on the digital television 701 or an instruction manual and such of the digital television 701. However, in accordance with the third embodiment, the user is able to input the input sound to the sound input module 412 of the mobile terminal 710 on hand by looking at the auxiliary information arranged on the screen G1. When the user remembers the type of content data corresponding to each of the content images A to D, the user may input the input sound including “television”, “photograph”, “website”, and such without displaying the auxiliary information.

As in the foregoing, in accordance with the digital television 701 in the third embodiment, the user can tell what kind of input sound input to specify a content image to be transmitted, without reading help information or an instruction manual and such of the digital television 701, whereby the burden on the user when inputting the input sound can be reduced.

In the third embodiment, explained has been an example of the auxiliary information display command receiver 703 and the auxiliary information display controller 704 of the digital television 701 and the auxiliary information display command transmitter 712 of the mobile terminal 710 being applied to the information processing system 400 in the second embodiment. However, the auxiliary information display command receiver 703 and the auxiliary information display controller 704 of the digital television 701 and the auxiliary information display command transmitter 712 of the mobile terminal 710 can be applied to the information processing system 1 in the first embodiment. Accordingly, the user is able to tell that photographing which part of the screen G by the image input module 202 can specify what type of content data.

As described above, in accordance with the first to the third embodiments, an intuitive and easy-to-understand operational feeling can be provided to the user when specifying a content image to be transmitted from among a plurality of content images displayed on the display module.

The computer programs executed by the digital televisions 100, 401, and 701 and by the mobile terminals 200, 410, and 710 are embedded in a read only memory (ROM) and such in advance, and provided.

The computer programs executed by the digital televisions 100, 401, and 701 and by the mobile terminals 200, 410, and 710 may be configured to be provided in a file of an installable format or an executable format recorded on a computer readable recording medium such as a compact disc read only memory (CD-ROM), a flexible disk (FD), a compact disc recordable (CD-R), and a digital versatile disk (DVD).

Furthermore, the computer programs executed by the digital televisions 100, 401, and 701 and by the mobile terminals 200, 410, and 710 may be configured to be stored on a computer connected to a network such as the Internet and to be provided by downloading it via the network. The programs executed by the digital televisions 100, 401, and 701 and by the mobile terminals 200, 410, and 710 may further be configured to be provided or distributed via a network such as the Internet.

The computer programs executed by the digital televisions 100, 401, and 701 in the first to the third embodiments comprise modular configuration comprising the respective modules in the foregoing (the content display controller 102, the display situation storage module 104, the image receiver 105, the content specifying modules 106 and 404, the content transmitter 107, the sound receiver 403, the auxiliary information display command receiver 703, and the auxiliary information display controller 704). As the actual hardware, a CPU (processor) reads out the program from the above-described ROM and executes it to load each of the foregoing modules on a main storage device, whereby the content display controller 102, the display situation storage module 104, the image receiver 105, the content specifying modules 106 and 404, the content transmitter 107, the sound receiver 403, the auxiliary information display command receiver 703, and the auxiliary information display controller 704 are generated on the main storage device.

Furthermore, the computer programs executed by the mobile terminals 200, 410, and 710 in the first to the third embodiments comprise a modular configuration comprising the respective modules in the foregoing (the image input module 202, the image transmitter 203, the content receiver 204, the content display controller 205, the sound input module 412, the sound transmitter 413, and the auxiliary information display command transmitter 712). As the actual hardware, a CPU (processor) reads out the program from the above-described ROM and executes it to load each of the foregoing modules on a main storage device, whereby the image input module 202, the image transmitter 203, the content receiver 204, the content display controller 205, the sound input module 412, the sound transmitter 413, and the auxiliary information display command transmitter 712 are generated on the main storage device.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a display controller configured to cause a display module to display a screen on which a plurality of content images based on a plurality of pieces of content data are arranged; and
a transmitter configured to receive a captured image comprising at least one of the content images in at least a portion of the captured image, to specify a content image to be transmitted based on the captured image and the at least one of the content images, and to transmit one of the pieces of content data corresponding to the content image to be transmitted to a predetermined external device.

2. The information processor of claim 1, wherein the transmitter is configured to specify, as the content image to be transmitted, one of the content images with a degree of similarity to the captured image of higher than a preset value, from among the content images.

3. The information processor of claim 2, wherein the transmitter is configured to specify, as the content image to be transmitted, one of the content images having a display history with a degree of similarity to the captured image of higher than a present value, from among the content images.

4. The information processor of claim 2, wherein the transmitter is configured to specify, as the content image to be transmitted, one of the content images comprising an area, a degree of similarity of which to the captured image is higher than a preset value and a ratio of which within the one of the content images is greater than or equal to a predetermined ratio, from among the content images.

5. The information processor of claim 1, further comprising a receiver configured to receive captured image data representing the captured image from the external device.

6. An information processor comprising:
a display controller configured to cause a display module to display a screen on which a plurality of content images base on a plurality pieces of content data are arranged; and
a transmitter configured to specify a content image to be transmitted from among the content images based on an input sound representing a position of the content image on the screen and a type of one of the pieces of content data corresponding to the content image, and to transmit the one of the pieces of content data corresponding to the content image to be transmitted to a predetermined external device.

7. The information processor of claim 6, wherein the display controller is configured to cause the display module to display textual information representing the type of the pieces of the content data.

8. The information processor of claim 7, wherein the display controller is configured to superimpose the textual information on at least one of the content images that is based on at least one of the pieces of content data of the type represented by the textual information, and to cause the display module to display the at least one of the content images on which the textual information is superimposed.

9. An information processing method performed by an information processor, the information processing method comprising:
causing, by a display controller, a display module to display a screen on which a plurality of content images based on a plurality of pieces of content data are arranged;
receiving, by a transmitter, a captured image comprising at least one of the content images in at least a portion of the captured image;
specifying, by the transmitter, a content image to be transmitted based on the captured image and the at least one of the content images; and
transmitting, by the transmitter, one of the pieces of content data corresponding to the content image to be transmitted to a predetermined external device.
